(19) United States
(12) Patent Application Publication
(10) Pub. No.: US 2018/0221903 A1
(43) Pub. Date: Aug. 9, 2018

(54) Method and Device for Coating Frame Sealant

(71) Applicants: BOE TECHNOLOGY GROUP CO., LTD., Beijing (CN); ORDOS YUANSHENG OPTOELECTRONICS CO., LTD., Ordos, Inner Mongolia (CN)

(72) Inventors: Shuai CHEN, Beijing (CN); Rima BAO, Beijing (CN); Zhuo CHEN, Beijing (CN); Jianwei GUO, Beijing (CN); Mingming GAO, Beijing (CN)

(73) Assignees: BOE TECHNOLOGY GROUP CO., LTD., Beijing (CN); ORDOS YUANSHENG OPTOELECTRONICS CO., LTD., Ordos, Inner Mongolia (CN)

(21) Appl. No.: 15/569,368

(22) PCT Filed: May 15, 2017
(86) PCT No.: PCT/CN2017/084325

§ 371 Date: Oct. 25, 2017

(30) Foreign Application Priority Data
Jun. 30, 2016 (CN) 201610509762.3

(51) Int. Cl. B05B 13/04; B05D 1/02

(52) U.S. Cl. CPC B05B 13/041; B05D 1/025

(57) ABSTRACT

A method of coating frame sealant and device are disclosed, to coat areas having different shapes and widths with the frame sealant. The method of coating frame sealant comprises the steps of dividing an area to be coated with frame sealant on a display panel into different subareas based on a contour of the area, the subareas comprising a linear-type subarea to be coated with the frame sealant and a curve-type subarea to be coated with the frame sealant; providing a coating instruction for each subarea to be coated with the frame sealant among the different subareas; and coating the frame sealant to the subarea according to the coating instruction.

### CROSS-REFERENCE OF RELATED APPLICATIONS

The present application is the U.S. national phase entry of PCT/CN2017/084325, with an international filling date of May 15, 2017, which claims the benefit of Chinese Patent Application No. 201610509762.3, filed on Jun. 30, 2016 with the Patent Office of China, the entire disclosure of which is incorporated herein by reference.

### TECHNICAL FIELD

The present disclosure relates to the field of display device manufacture, and particularly to a method and device for coating frame sealant.

### BACKGROUND

With the development of science and technology, it is required that the contour shape of frame sealant formed in a display device should be more and more diversified. However, with the current coating machine for coating frame sealant, the resulting contour shapes of the coated frame sealant are rather limited. On the one hand, the current coating machine can only coat frame sealant on horizontal and vertical patterns, which may be, for example, in the shapes of the Chinese character “ [symbol] ” (i.e., straight line), the letter “ [symbol] ” or the Chinese character “ [symbol] ” (i.e., rectangle), also may be “ [symbol] ”-shaped. While for a display panel having an irregular shape, the frame sealant patterns obtained by coating would not have a good frame-sealing performance.

On the other hand, the current coating machine usually performs frame sealant coating in a uniform manner, so that the frame sealant coated on the display panel has a uniform width. But in fact, different areas on the display panel have different requirements for the width of the coated frame sealant.

For instance, the four edges and four corners of the display panel may have different requirements for the width of the coated frame sealant. The bond strength of the coated frame sealant is related to the width thereof. The greater is the width of the coated frame sealant, the stronger is the bond strength, or otherwise, the narrower is the coated frame sealant, the weaker is the bond strength. Peeling is more likely to occur in the four corners than the four edges of the display panel, so the four corners have a higher requirement for bond strength of the coated frame sealant than the four edges. Therefore, the width of the coated frame sealant at the four corners of the display panel shall be wider than that at the four edges.

### SUMMARY

An object of the present disclosure is to provide a method of coating frame sealant and device for coating areas having different contour shapes with the frame sealant, so as to achieve flexibility and diversity in frame sealant coating.

In an aspect, an embodiment of the present disclosure provides a method of coating frame sealant, comprising: dividing an area to be coated with frame sealant on a display panel into different subareas based on a contour of the area, the subareas comprising a linear-type subarea to be coated with the frame sealant and a curve-type subarea to be coated with the frame sealant; providing a coating instruction for each subarea to be coated with the frame sealant among the different subareas; and coating the frame sealant to the subarea according to the coating instruction.

In some embodiments, the step of providing a coating instruction for each subarea to be coated with the frame sealant among the different subareas comprises determining a movement speed, a moving direction and a moving distance of the display panel, determining a movement speed, a moving direction and a moving distance of a nozzle for the subareas to be coated with the frame sealant, the moving direction of the display panel and the moving direction of the nozzle being orthogonal to each other, and the nozzle being used for spraying the frame sealant to a surface of the display panel.

In some embodiments, determining the movement speed of the display panel and the movement speed of the nozzle for the different subareas to be coated with the frame sealant comprises:

for the linear-type subarea to be coated with the frame sealant, setting at least one of the movement speed of the display panel and the movement speed of the nozzle to be constant, and for the curve-type subarea to be coated with the frame sealant, setting at least one of the movement speed of the display panel and the movement speed of the nozzle to be accelerated or decelerated.

In some embodiments, the movement speed of the display panel and the movement speed of the nozzle are both set to be constant for the linear-type subarea to be coated with the frame sealant.

In other embodiments, for the linear-type subarea to be coated with the frame sealant, one of the movement speed of the display panel and the movement speed of the nozzle is set to be constant, and the other one is zero.

In some embodiments, the step of providing a coating instruction for each subarea to be coated with the frame sealant among the different subareas further comprises determining a sealant discharging speed of the nozzle for widths of the different subareas to be coated with the frame sealant.

In some embodiments, the step of providing a coating instruction for each subarea to be coated with the frame sealant among the different subareas further comprises:

for the linear-type subarea to be coated with the frame sealant, determining the moving direction and moving distance of the display panel, as well as the moving direction and moving distance of the nozzle, based on a coordinate of a starting point of each subarea and a relative coordinate of an ending point relative to the starting point of the subarea; and

for the curve-type subarea to be coated with the frame sealant, determining the moving direction and moving distance of the display panel, as well as the moving direction and moving distance of the nozzle, based on a coordinate of a starting point of each subarea, a relative coordinate of an ending point relative to the starting point of the subarea, and relative coordinates of at least one passing points of the curve-type subarea to be coated with the frame sealant.

In some embodiments, the method further comprises, prior to providing a coating instruction for each subarea to be coated with the frame sealant among the different subareas, determining a coordinate reference system for the area to be coated with the frame sealant on the display panel; and dividing the linear-type subarea to be coated with the frame sealant into a horizontal subarea, a vertical subarea and an oblique subarea under the coordinate reference system.

In some embodiments, the method further comprises the step of when coating the frame sealant to the subarea according to the coating instruction, controlling the nozzle to move up and down in a direction perpendicular to a plane where the display panel lies, so as to keep the nozzle at a constant distance from a surface of the display panel.

In some embodiments, the step of coating the frame sealant to the subarea according to the coating instruction comprises storing the coating instructions for each subarea to be coated with the frame sealant, and coating the subarea continuously according to the stored coating instructions.

In some embodiments, the different subareas to be coated with the frame sealant are connected to each other to form an enclosed pattern, and a coating starting point of a first subarea that is coated firstly does not coincide with a coating ending point of a last subarea that is coated lastly, and the coating ending point surpasses the coating starting point.

In another aspect, based on the method of coating frame sealant herein, a frame sealant coating device is further provided in the present disclosure, comprising:

a subarea division unit, for dividing an area to be coated with frame sealant on a display panel into different subareas based on a contour of the area, the subareas comprising a linear-type subarea to be coated with the frame sealant and a curve-type subarea to be coated with the frame sealant; a coating instruction provision unit electrically connected with the subarea division unit, for providing a coating instruction for each subarea to be coated with the frame sealant among the different subareas; and a coating unit electrically connected with the coating instruction provision unit, the coating unit comprising a platform for carrying the display panel and a coating head for securing a nozzle, the coating unit being used for coating the subareas according to the coating instruction.

In some embodiments, the coating instruction provision unit comprises a speed provision module for providing a movement speed of the display panel, as well as the movement speed of the nozzle for the different subareas; and a direction and distance provision module for providing information regarding a moving direction and a moving distance of the display panel, as well as a moving direction and a moving distance of the nozzle for the different subareas to be coated with the frame sealant, the moving direction of the display panel and the moving direction of the nozzle being orthogonal to each other.

Further, in some embodiments, the frame sealant coating device further comprises a monitor unit for detecting a distance between the nozzle and the display panel, the monitor unit is electrically connected with the coating unit, for controlling an up-down movement of the nozzle in a direction perpendicular to a plane where the display panel lies, so as to keep the nozzle at a constant distance from a surface of the display panel.

method of coating frame sealant

### BRIEF DESCRIPTION OF DRAWINGS

The drawings explained herein are used to provide further understanding to the disclosure, which constitutes a part of the disclosure. The embodiments and their description in the description are intended to explain the disclosure and do not constitute undue limitations to the invention. In the following drawings:

FIG. 1 is a schematic flow chart of a method of coating frame sealant provided by an embodiment of the present disclosure;

FIG. 2 is an overall schematic view of contour shapes of a plurality of areas to be coated with the frame sealant on a display panel in an embodiment of the disclosure;

FIG. 3 is a schematic view of the contour shape of the area to be coated with the frame sealant in the lower left corner of the view in FIG. 2;

FIG. 4 is a detailed schematic view for the embodiment shown in FIG. 1; and

FIG. 5 is a schematic view of a frame sealant coating device provided by an embodiment of the present disclosure.

### DETAILED DESCRIPTION OF EMBODIMENTS

For easy understanding, a method of coating frame sealant provided by embodiments of the present disclosure will be described in detail with reference to the drawings.

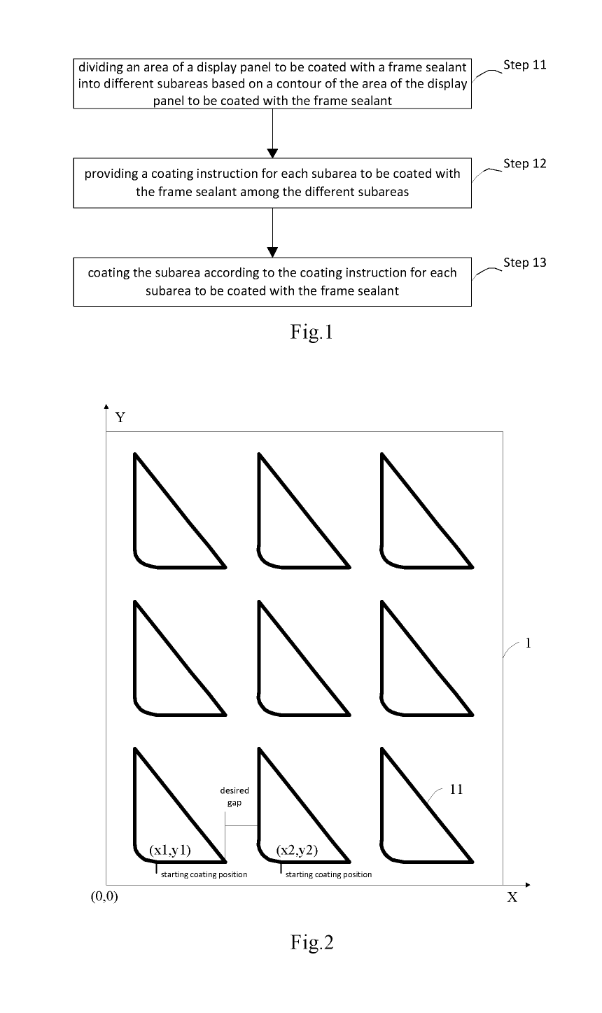

Referring to FIG. 1, the method of coating frame sealant provided by an embodiment of the present disclosure comprises the following steps.

Step 11: dividing an area of a display panel to be coated with a frame sealant into different subareas based on a contour of the area of the display panel to be coated with the frame sealant, the subareas comprising a linear-type subarea to be coated with the frame sealant and a curve-type subarea to be coated with the frame sealant;

Step 12: providing a coating instruction for each subarea to be coated with the frame sealant among the different subareas; and

Step 13: coating the subarea according to the coating instruction for each subarea to be coated with the frame sealant.

In this embodiment, depending on the overall contour of the area to be coated with the frame sealant of the display panel, the area to be coated with the frame sealant is divided into different subareas with different shapes (e.g., linear contours, curved contours), for each of which a corresponding coating instruction is provided respectively. In this way, by partitioning the area to be coated, it is possible to coat areas having various contour shapes with the frame sealant, so as to achieve flexibility and diversity in frame sealant coating.

In practical coating, a nozzle is installed on the coating head of a coating device, the display panel is placed on the platform of the coating device, the platform can move in the X direction, and the coating head can move in the Y direction. During coating, the frame sealant is squeezed into a pump through pressurization by nitrogen (N₂) gas, and evenly discharged through the nozzle by means of rotation of a screw in the pump. By controlling movement speeds of the display panel and of the nozzle, the linear-type and curve-type frame sealant contours can be made.

For instance, in regard to the linear-type subarea to be coated with the frame sealant, at least one of the movement speed of the display panel and the movement speed of the nozzle may be constant. In some embodiments, for the linear-type subarea to be coated with the frame sealant, both the movement speed of the display panel and the movement speed of the nozzle can be constant. In other embodiments, one of the movement speed of the display panel and the movement speed of the nozzle can be set to be uniform, and the other one to be zero. In regard to the curve-type subarea to be coated with the frame sealant, at least one of the movement speed of the display panel and the movement speed of the nozzle can be accelerated or decelerated.

In some embodiments, based on the principle that two points determine a line, for the linear-type subarea to be coated with the frame sealant, the moving direction and moving distance of the display panel, as well as the moving direction and moving distance of the nozzle, can be determined based on the coordinates of the starting point of each subarea and the coordinates of the ending point relative to the starting point of the subarea. According to the principle that three points determine an arc, in regard to the curve-type subarea to be coated with the frame sealant, the moving direction and moving distance of the display panel, as well as the moving direction and moving distance of the nozzle, can be determined based on the coordinate of the starting point of each subarea, the coordinates of the ending point relative to the starting point of the same subarea, and the coordinates of at least one passing point in the curve-type subarea to be coated with the frame sealant. As for any irregularly shaped area to be coated with the frame sealant on the display panel, it can be subdivided into multiple arcs and straight lines that are connected end to end. The finer is the division, the more precise is the description to the area to be coated with the frame sealant. The frame sealant contours of various shapes indicated in the embodiments of the present disclosure comprise not only linear-type and curve-type frame sealant contours, but also frame sealant contours having variable widths. The width of the frame sealant contour mainly depends on the amount of the discharged frame sealant. The parameters that affect the amount of the discharged frame sealant mainly include the size of the nozzle, the distance between the nozzle and the display panel, the movement speed of the display panel, the movement speed of the nozzle, the rotation speed of the screw in the nozzle, etc. Among the above parameters, the smaller the distance between the nozzle and the display panel, the smaller the movement speed of the display panel and the movement speed of the nozzle, the faster the sealant discharging speed of the nozzle, the greater the amount of the discharged frame sealant, and the greater the width of the coated frame sealant contour. After the coating gets started, the size of the nozzle may not be changed arbitrarily (because the nozzle cannot be replaced at will). Nevertheless, the parameters such as the distance between the nozzle and the display panel, the movement speed of the display panel, the movement speed of the nozzle, and the sealant discharging speed of the nozzle can be adjusted at any time by controlling respective mechanisms.

Thus, in some embodiments, the step of providing a coating instruction for each subarea among the different subareas to be coated with the frame sealant comprises a step of determining the sealant discharging speed of the nozzle for the different subareas to be coated with the frame sealant, alternatively, comprises a step of determining the distance between the nozzle and the display panel for the different subareas to be coated with the frame sealant. In this way, in combination with the movement speed of the display panel and the movement speed of the nozzle, the frame sealant contours having different widths can be coated.

Next, the method of coating frame sealant provided by the embodiment shown in FIG. 1 will be introduced in detail with reference to FIGS. 4 and 2. FIG. 2 is an overall schematic view of contours of a plurality of areas to be coated with the frame sealant on a display panel. On the display panel 1 shown in FIG. 2, nine areas 11 to be coated with the frame sealant are shown. Each of the contours of the areas 11 to be coated with the frame sealant is substantially in the shape of a right triangle with an arc as a transition at its right angle. In regard to the area to be coated with the frame sealant shown in FIG. 2, the method of coating frame sealant may comprise the following steps.

Step 41: placing the display panel. The display panel 1 is disposed on a platform, the nozzle is installed on a coating head, and the position of the display panel on the platform can be adjusted by θ axis of the platform such that the orientation of the display panel on the platform is the same as the platform. Only the display panel is securely installed and aligned with the platform, it can allow the frame sealant to be coated in the correct position.

Step 42: determining a coordinate reference system for the area to be coated with the frame sealant on the display panel, and determining a starting coating position of each area to be coated with the frame sealant. Then, under the coordinate reference system, the linear-type subarea to be coated with the frame sealant may be further subdivided into a horizontal subarea to be coated with the frame sealant, a vertical subarea to be coated with the frame sealant, and an oblique subarea to be coated with the frame sealant.

After the coordinate reference system is determined, the starting coating position of each area 11 to be coated with the frame sealant can be determined based on the desired size of each area 11 and the desired gap between two adjacent areas 11. For instance, the lower left corner of the display panel 1 can be first set as the origin (0, 0) of the coordinate system, and then the position of each area 11 to be coated with the frame sealant can be determined based on the overall size of the display panel and the origin that has been determined.

For instance, in FIG. 2, the starting point of a horizontal subarea of the area to be coated with the frame sealant in the first lower left corner may be determined as the starting coating position of this area to be coated with the frame sealant, the coordinate (x₁, y₁) of the starting coating position with respect to the origin can be determined based on the desired size of each area 11 and the desired gap between adjacent areas 11, and can be used as the starting coating coordinates (x₁, y₁) of the first area 11 to be coated with the frame sealant, e.g., it may be (10, 5), which is in the unit of mm. Then, the starting coating position (x₂, y₂) for the second area 11 in the lower left corner of the display panel 1 can be determined based on the desired size of this area 11 to be coated with the frame sealant and the desired gap between it and the next area 11 to be coated, e.g., the starting coating position (x₂, y₂) may be (40, 5), which is in the unit of mm. By analog, the starting coating position for each area 11 can be determined.

The starting coating position of each area to be coated with the frame sealant can be determined in preparation for the subsequent frame sealant coating.

Step 43: providing a coating instruction for each area to be coated with the frame sealant.

Since all the areas 11 to be coated with the frame sealant in FIG. 2 have the same shape, only the first area 11 in the lower left corner of the display panel 1 is taken as an example for illustration. The step of providing a coating instruction for the area 11 to be coated with the frame sealant may comprise the following steps.

Step 431: dividing the area to be coated with the frame sealant into different subareas based on the contour of the area to be coated with the frame sealant on the display panel, the subareas comprising a linear-type subarea to be coated with the frame sealant and a curve-type subarea to be coated with the frame sealant.

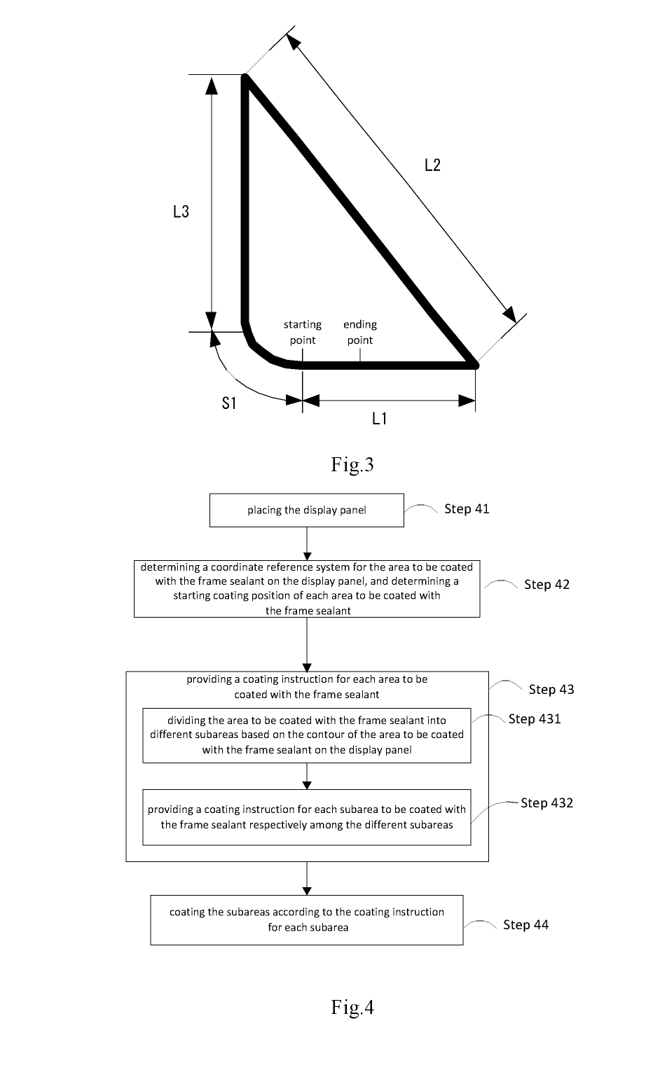

For instance, as shown in FIG. 3, the first area 11 to be coated with the frame sealant in the lower left corner of the display panel 1 in FIG. 2 can be divided into four different subareas, which are respectively a horizontal subarea L1, an oblique subarea L2, a vertical subarea L3 and a curved subarea S1.

Step 432: providing a coating instruction for each subarea to be coated with the frame sealant respectively among the different subareas.

In this step, the parameters involved in the coating instruction may comprise the distance (represented as Gap) between the nozzle and the display panel, the movement speed (indicated by V₁) of the display panel, the movement speed (indicated by V₂) of the nozzle, the sealant discharging speed (indicated by S) of the nozzle, the coordinate (indicated by x, y and specific values) of the starting point of each subarea, the relative coordinate (indicated by Δx₂, Δy₂ and specific values) of the ending point with respect to the starting point of the subarea and the relative coordinate (indicated by Δx₁, Δy₁; Δx₂, Δy₂ and specific values) of a passing point in the curved subarea.

For example, for those four divided subareas shown in FIG. 3, the coating parameters may be described as follows:

the horizontal subarea L1 to be coated with the frame sealant:

Gap:25 um+V1:170 mm/s+V2:0+S:3000 pps/s+x:10 mm+y:5 mm+Δx₂:25 mm+Δy₂:0;

the oblique subarea L2 to be coated with the frame sealant:

Gap:25 um+V₁:170 mm/s+V₂:227 mm/s+S:3000 pps/s+x:35 mm+y:5 mm+Δx₂:−30 mm+Δy₂:40 mm;

the vertical subarea L3 to be coated with the frame sealant:

Gap:25 um+V₁:0+V2:227 mm/s+S:3000 pps/s+x:5 mm+y:45 mm+Δx₂:0+Δy₂:−35 mm;

the curved subarea S1 to be coated with the frame sealant:

Gap:25 um+V₁:30 mm/s(acceleration:500 mm/s²)+V₂:30 mm/s(acceleration:1500 mm/s²)+S:3000 pps/s+x:5 mm+y:10 mm+Δx₁:2 mm+Δy₁:−4 mm+Δx₂:5 mm+Δy₂:−5 mm.

In this embodiment, the curved subarea S1 to be coated with the frame sealant has a radius of 5 mm, (Δx₁,Δy₁) is the relative coordinate of the passing point in the arc with respect to the starting point of the curved subarea S1, and (Δx₂,Δy₂) is the relative coordinate of the ending point in the arc with respect to the starting point of the curved subarea S1 to be coated with the frame sealant.

Among the above coating parameters, “pps/s” refers to the number of pulses per second of a servo motor in the nozzle for driving the screw in rotation. And in the coating instructions, the parameters are in fact independent from each other, and the sign “+” only indicates that the related parameters are required to be determined simultaneously, rather than meaning these parameters shall be combined or added.

Step 44, coating the subareas according to the coating instruction for each subarea.

In some embodiments, the coating instruction for each subarea to be coated with the frame sealant can be stored first. In this way, it is possible to continuously perform coating to the divided subareas in sequence and apply the coating instruction that is already set for a certain subarea to the next subarea to be coated with the frame sealant having the same shape and width. For instance, the coating instructions for the first area to be coated with the frame sealant in the lower left corner in the embodiment shown in FIG. 2 can be applied to the other eight areas to be coated with the frame sealant on the display panel 1, with no need of reproviding the coating instructions.

The area to be coated with the frame sealant as shown in FIG. 3 can be coated in the following coating sequence: the horizontal subarea L1—the oblique subarea L2—the vertical subarea L3—the curved subarea S1.

Besides, in step 44, while coating the subareas to be coated with the frame sealant, it is possible to control the up-down movement of the nozzle in the direction perpendicular to the plane where the display panel lies, so as to keep the nozzle at a constant distance from the surface of the display panel. The surface of the display panel has been formed with patterns, so the surface of the display panel may be uneven. As stated above, the distance (indicated by Gap) between the nozzle and the display panel, the movement speed of the display panel, the movement speed of the nozzle, the sealant discharging speed of the nozzle and the like may affect the amount of discharged sealant, and further affect the width of the coated frame sealant. Thus, by keeping the distance between the nozzle and he surface of the display panel substantially unchanged, it is possible that the width of the coated frame sealant mainly depends on the movement speed of the display panel, the movement speed of the nozzle and the sealant discharging speed of the nozzle, so as to facilitate an easy control to the width of the coated frame sealant. It shall be noted that the steps 41 and 42 do not necessarily go before the step 43, and the step 43 can be conducted before the steps 41 and 42. Meanwhile, the orders of the steps 41 and 42 can be exchanged.

In some embodiments, the different subareas to be coated with the frame sealant obtained by division to the area to be coated with the frame sealant are connected to each other to form an enclosed pattern, the coating starting point for a first subarea to be coated with the frame sealant that is coated first does not coincide with the coating ending point for a last subarea to be coated with the frame sealant that is coated last, and the coating ending point surpasses the coating starting point in such a way that a fully jointed contour without no clearance can be formed in the area to be coated with the frame sealant. For instance, as shown in FIG. 3, there are a coating starting point and a coating ending point that do not coincide with each other in the area to be coated with the frame sealant, that is, there is a distance between the coating starting point and the coating ending point and the coating ending point surpasses the coating starting point. In an embodiment, for the area between the coating starting point and the coating ending point, a corresponding instruction can be configured using the method of coating frame sealant to perform coating twice for the area between the coating starting point and the coating ending point, such that the sum of the two coating widths is equal to the width of the subarea to be coated with the frame sealant where the coating starting point and the coating ending point lie.

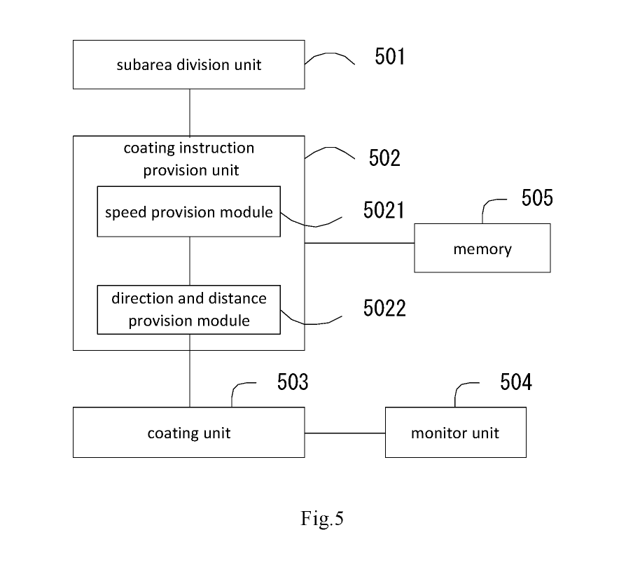

In addition to the method of coating frame sealant, another embodiment of the present disclosure provides a frame sealant coating device, as shown in FIG. 5, which comprises: a subarea division unit 501 for dividing the area to be coated with the frame sealant on the display panel into different subareas based on the contour shape of the area, the subareas to be coated with the frame sealant comprising a linear-type subarea and a curve-type subarea; a coating instruction provision unit 502 that is electrically connected with the subarea division unit 501 and used for providing a coating instruction for each subarea to be coated with the frame sealant among the different subareas; and a coating unit 503 that is electrically connected with the coating instruction provision unit 502 and comprises a platform for carrying the display panel and a coating head for securing a nozzle, the coating unit 503 being used for coating the subareas to be coated with the frame sealant based on the coating instruction configured for each subarea.

The subarea division unit 501 may comprise a controller used for identifying and classifying line types in the area to be coated with the frame sealant on the display panel. The controller can be implemented by means of software, for example, the controller may comprise graphics processing software capable of calculating the curvature and slope of various segments of the outline of the contour of the area to be coated with the frame sealant, and identifying and determining the different subareas to be coated with the frame sealant. It can be understood that dividing lines between the different subareas to be coated with the frame sealant can be determined manually on the basis of the contour of the area to be coated with the frame sealant on the display panel.

In an example shown in FIG. 5, the coating instruction provision unit 502 comprises a speed provision module 5021 for providing the movement speed of the display panel, as well as the movement speed of the nozzle for different subareas to be coated with the frame sealant; and a direction and distance provision module 5022 for providing information regarding the moving direction and moving distance of the display panel, as well as the moving direction and moving distance of the nozzle for the different subareas to be coated with the frame sealant, the moving direction of the display panel and the moving direction of the nozzle being orthogonal to each other.

Moreover, the frame sealant coating device may further comprise a monitor unit 504 for detecting the distance between the nozzle and the display panel and a memory 505. The monitor unit 504 is electrically connected with the coating unit 503. The nozzle is controlled on the basis of the detection information from the monitor unit 504 to move up and down in the direction perpendicular to the plane where the display panel lies, to keep the nozzle at a constant distance from the surface of the display panel. The memory 505 is electrically connected with the coating instruction provision unit 502 to store all the preset coating instructions. Examples of the monitor unit 504 include, but are not limited to, a laser ranger, an infrared ranger, a digital vernier caliper and the like.

The frame sealant coating device provided in the present disclosure can be used to carry out the method of coating frame sealant to perform coating to the areas having various shapes and adjustable widths with the frame sealant, so as to achieve flexibility and diversity in frame sealant coating.

Specific features, structures, materials or characteristics described in the above embodiments can be combined in any suitable manner to form other embodiments.

What have been stated above are merely some example embodiments of the present invention, and the scope of the present invention is not limited thereto. Variations or replacements that can be readily envisaged by those skilled in the art within the technical scope of the present disclosure shall fall within the scope of the present invention. Thus, the protection scope of the invention shall depend on the appended claims.

1. A method of coating frame sealant, comprising:
dividing an area to be coated with frame sealant on a display panel into different subareas based on a contour of the area, the subareas comprising a linear-type subarea to be coated with the frame sealant and a curve-type subarea to be coated with the frame sealant;
providing a coating instruction for each subarea to be coated with the frame sealant among the different subareas; and
coating the frame sealant to the subarea according to the coating instruction.

2. The method according to claim 1, wherein the step of providing a coating instruction for each subarea to be coated with the frame sealant among the different subareas comprises:
determining a movement speed, a moving direction and a moving distance of the display panel, determining a movement speed, a moving direction and a moving distance of a nozzle for the subareas to be coated with the frame sealant, the moving direction of the display panel and the moving direction of the nozzle being orthogonal to each other, and the nozzle being used for spraying the frame sealant to a surface of the display panel.

3. The method according to claim 2, wherein determining the movement speed of the display panel and the movement speed of the nozzle for the different subareas to be coated with the frame sealant comprises:
for the linear-type subarea to be coated with the frame sealant, setting at least one of the movement speed of the display panel and the movement speed of the nozzle to be constant, and
for the curve-type subarea to be coated with the frame sealant, setting at least one of the movement speed of the display panel and the movement speed of the nozzle to be accelerated or decelerated.

4. The method according to claim 3, wherein the movement speed of the display panel and the movement speed of the nozzle are both set to be constant for the linear-type subarea to be coated with the frame sealant.

5. The method according to claim 3, wherein for the linear-type subarea to be coated with the frame sealant, one of the movement speed of the display panel and the movement speed of the nozzle is set to be constant, and the other one is zero.

6. The method according to claim 2, wherein the step of providing a coating instruction for each subarea to be coated with the frame sealant among the different subareas further comprises determining a sealant discharging speed of the nozzle for widths of the different subareas to be coated with the frame sealant.

7. The method according to claim 2, wherein the step of providing a coating instruction for each subarea to be coated with the frame sealant among the different subareas further comprises:
for the linear-type subarea to be coated with the frame sealant, determining the moving direction and moving distance of the display panel, as well as the moving direction and moving distance of the nozzle, based on a coordinate of a starting point of each subarea and a relative coordinate of an ending point relative to the starting point of the subarea; and
for the curve-type subarea to be coated with the frame sealant, determining the moving direction and moving distance of the display panel, as well as the moving direction and moving distance of the nozzle, based on a coordinate of a starting point of each subarea, a relative coordinate of an ending point relative to the starting point of the subarea, and relative coordinates of at least one passing points of the curve-type subarea to be coated with the frame sealant.

8. The method according to claim 1, wherein the method further comprises:
prior to providing a coating instruction for each subarea to be coated with the frame sealant among the different subareas, the method further comprises:
determining a coordinate reference system for the area to be coated with the frame sealant on the display panel; and
dividing the linear-type subarea to be coated with the frame sealant into a horizontal subarea, a vertical subarea and an oblique subarea under the coordinate reference system.

9. The method according to claim 2, wherein the method further comprises the step of:
when coating the frame sealant to the subarea according to the coating instruction, controlling the nozzle to move up and down in a direction perpendicular to a plane where the display panel lies, so as to keep the nozzle at a constant distance from a surface of the display panel.

10. The method according to claim 1, wherein the step of coating the frame sealant to the subarea according to the coating instruction comprises:
storing the coating instructions for each subarea to be coated with the frame sealant, and coating the subarea continuously according to the stored coating instructions.

11. The method according to claim 1, wherein the different subareas to be coated with the frame sealant are connected to each other to form an enclosed pattern, and wherein a coating starting point of a first subarea that is coated firstly does not coincide with a coating ending point of a last subarea that is coated lastly, and the coating ending point surpasses the coating starting point.

12. A frame sealant coating device, comprising:
a subarea division unit, for dividing an area to be coated with frame sealant on a display panel into different subareas based on a contour of the area, the subareas comprising a linear-type subarea to be coated with the frame sealant and a curve-type subarea to be coated with the frame sealant;
a coating instruction provision unit electrically connected with the subarea division unit, for providing a coating instruction for each subarea to be coated with the frame sealant among the different subareas; and
a coating unit electrically connected with the coating instruction provision unit, the coating unit comprising a platform for carrying the display panel and a coating head for securing a nozzle, the coating unit being used for coating the subareas according to the coating instruction.

13. The frame sealant coating device according to claim 12, wherein the coating instruction provision unit comprises:
a speed provision module for providing a movement speed of the display panel, as well as the movement speed of the nozzle for the different subareas; and
a direction and distance provision module for providing information regarding a moving direction and a moving distance of the display panel, as well as a moving direction and a moving distance of the nozzle for the different subareas to be coated with the frame sealant, the moving direction of the display panel and the moving direction of the nozzle being orthogonal to each other.

14. The frame sealant coating device according to claim 12, further comprising a monitor unit for detecting a distance between the nozzle and the display panel, wherein the monitor unit is electrically connected with the coating unit, for controlling an up-down movement of the nozzle in a direction perpendicular to a plane where the display panel lies, so as to keep the nozzle at a constant distance from a surface of the display panel.

15. The frame sealant coating device according to claim 13, further comprising a monitor unit for detecting a distance between the nozzle and the display panel, wherein the monitor unit is electrically connected with the coating unit, for controlling an up-down movement of the nozzle in a direction perpendicular to a plane where the display panel lies, so as to keep the nozzle at a constant distance from a surface of the display panel.

16. The method according to claim 3, wherein the method further comprises the step of:
when coating the frame sealant to the subarea according to the coating instruction, controlling the nozzle to move up and down in a direction perpendicular to a plane where the display panel lies, so as to keep the nozzle at a constant distance from a surface of the display panel.

17. The method according to claim 4, wherein the method further comprises the step of:
when coating the frame sealant to the subarea according to the coating instruction, controlling the nozzle to move up and down in a direction perpendicular to a plane where the display panel lies, so as to keep the nozzle at a constant distance from a surface of the display panel.

18. The method according to claim 2, wherein the different subareas to be coated with the frame sealant are connected to each other to form an enclosed pattern, and wherein a coating starting point of a first subarea that is coated firstly does not coincide with a coating ending point of a last subarea that is coated lastly, and the coating ending point surpasses the coating starting point.

19. The method according to claim 3, wherein the different subareas to be coated with the frame sealant are connected to each other to form an enclosed pattern, and wherein a coating starting point of a first subarea that is coated firstly does not coincide with a coating ending point of a last subarea that is coated lastly, and the coating ending point surpasses the coating starting point.

20. The method according to claim 4, wherein the different subareas to be coated with the frame sealant are connected to each other to form an enclosed pattern, and wherein a coating starting point of a first subarea that is coated firstly does not coincide with a coating ending point of a last subarea that is coated lastly, and the coating ending point surpasses the coating starting point.
